(19) United States
(12) Patent Application Publication
(10) Pub. No.: US 2002/0042830 A1
(43) Pub. Date: Apr. 11, 2002

(54) System, method and applications real-time messaging over HTTP-based protocols

(76) Inventors: Subhra Bose, Manorville, NY (US); Paul A. Stirpe, Shoreham, NY (US)

Correspondence Address: Thomas A. O'Rourke, Waytt, Gerber & O'Rourke, 99 park Avenue, New York, NY, 10016, US

(21) Appl. No.: 09/824,541

(22) Filed: Apr. 2, 2001

Related U.S. Application Data
(60) Provisional application No. 60/193,757, filed on Mar. 31, 2000.

(51) Int. Cl. G06F 15/16

(52) U.S. Cl. 709/230; 709/218; 709/204

(57) ABSTRACT

A system for obtaining information is disclosed. The system comprises a server, a sender and a receiver and a communication means for the server to communicate with the sender and receiver. The receiver initiates a request message which is transmitted to the server. In the event the server is unable to immediately reply to the request with information for the receiver, the server retains the request in a pending state. The server retains the request in a pending state until a time when the server is able to respond to the request with information for the receiver and wherein at such time, the server allows for the completion of the receiver request with the information.

### BACKGROUND OF THE INVENTION

This application claims priority on U.S. Provisional Patent Application Ser. No. 60/193,757 filed Mar. 31, 2000, the disclosures of which are incorporated herein by reference.

1. Technical Field

The invention generally relates to Internet based messaging systems. More particularly, the invention includes a real-time messaging system, method and applications for use between any communicating entities that includes the use of but is not limited to the HTTP protocol (and its derivations) for communications. For example, web servers may need to send messages to web browsers in real-time. Furthermore, the messaging system utilizes the standard web based protocols to communicate and thus may operate through firewalls, proxy servers, packet filters or other filtering systems. The invention furthermore describes an event notification system that may use the real-time messaging capabilities to support real-time one-to-one, one-to-many and many-to-many communications. Furthermore, the invention describes practical applications of the real-time messaging system for use in distance learning (e-learning) applications where the trainer and the students are remotely located from each other, for example. The Interactive Question & Response (IQ&A) service provides for real-time question and response collaboration between students and the trainer during live, distance learning over the Internet, or any network. Several other applications of the invention are described including real-time polling, page flipping, group membership, alert notification, annotation application, follow-me browsing, instant messaging, chat, discussion groups, email notification, and text-based speech. The invention also includes providing the real-time messaging system as a service. Finally, the invention describes how the real-time system may be arranged in various configurations to provide for highly scalable real-time messaging for large-scale applications.

2. Related Information

The ability to instantly deliver messages to computers, machines of any kind, and/or users of computers or machines is critical to many Internet based business applications. Such applications may use the HTTP protocol for communications. For example, in manufacturing applications, computers may need to send and receive messages immediately to maintain accurate state of inventories, or the state of a product manufacturing system. Browser based email users may desire to obtain immediate notification that a new email message has arrived for viewing. Web-based financial applications may require users to receive market data instantly, as the data is created by the market place. Web-based healthcare applications may require real-time messaging to the physicians. Browser-based network management consoles often require real-time status information concerning the health of the network. Mobile device users may need to receive notifications or information in real-time.

Applications that have historically been utilized within enterprises are being migrated to the Internet, and as such, typically require the use of Internet technologies to be enabled for use over the Internet. Companies and/or institutions that have traditionally developed network-enabled applications for a variety of protocols are re-writing them to operate over IP networks, the foundation protocol on which Internet communications are based. Many traditional applications are being developed for operation within a Web browser container, such as Microsoft Internet Explorer or Netscape Navigator. Such applications are being rewritten to use standard Web technologies for delivery to the standard web browser container and to be carried over the Internet or other IP networks. The browser is typically the end user container within which the application is displayed and interacted with. Browser-based applications typically communicate with Web servers in an IP based communication system, for many of the application's capabilities, including but not limited to its look and feel. From herein forward, when we specify web server, we include any kind of server including but not limited to application servers.

A typical architecture for providing such Internet based communications is called the “Three Tier Architecture” as shown in FIG. 1. The invention is not limited to operation in the three-tier architecture, but may work in various other types of architectures. For example, the invention may be utilized in two tier architectures wherein the web server and database are combined. Also, the invention may be utilized for real-time communications between two or more web servers themselves. The invention may be used in architectures that incorporate wireless or satellite communications. The three-tier architecture is used herein for illustration purposes. The architecture in FIG. 1 is termed the three-tier architecture because there are three distinct tiers were different types of operations are performed. The database (100) is a persistent storage facility that stores the information required for business operations, such as transaction records, parts inventory information, usage and tracking information. The Web Servers (101,102) act as intermediaries between the end user's requests and replies for services and the database. One or more web servers may be used for load balancing or load sharing. Finally, the end users are typically people or computer programs operating from remote computers (110, 111, 112, 113) that may be located across an IP network, the Internet, intranets, extranets or other such network. Some remote computers (112, 113) may connect to the network via a dial-up connection into a local Internet Service Provider network. Other end user computers (110, 111) may connect to the network via a corporate or enterprise network (109) that has a permanent connection to the Internet typically via an Internet Service Provider (ISP). Other connection methods are possible including wireless, infrared, satellite, for example. The router 104 and 107 may maintain direct connections to the ISP, or can dialup to the ISP on demand when users have a need to interact with remotely located web servers.

In any case, the corporation or organization that administers the enterprise network may place one or more firewalls (108) between the enterprise network (109) and the Internet or ISP network (105). The firewall protects the enterprise network from malicious users or computer programs that may attempt to gain access to corporate assets or simply disrupt the enterprise network. As such, the firewalls are typically configured to block various types of protocols and connection types from coming into the enterprise and going from the enterprise network to the Internet or ISP network.

The web servers (101, 102) and database (100) are usually located at a hosting facility and are typically directly connected to an ISP. The firewall (103) located between the web servers and the Internet network may be configured to allow only certain kinds of requests from the Internet to the web servers and responses from the web servers back to the requesting entity. Only specific types of protocols or connection types may be permitted to pass through the firewall (103) to secure the web servers (101,102) and database (100), or other back-end systems. One or more firewall devices, proxy servers or in general filtering systems may be placed anywhere between the web servers and the end user machines (110,111,112,113). For example, a message may originate from a web server at a hosting facility to a web browser across the Internet. The message may pass through several ISP networks, each of which may have one or more filtering systems, finally arriving at the destination browser. From herein, we refer to filtering systems to include but not be limited to firewall devices or applications, proxy server devices or applications, packet filtering devices or applications.

As stated above, Internet users typically use a browser container to access Internet or web based services. The browser, by default, utilizes the HTTP protocol or protocol variants of HTTP (including but not limited to HTTPS, HTTPdav) to communicate with web servers. From herein forward, when we refer to the HTTP protocol, we also include all protocol variants. The HTTP protocol utilizes the TCP protocol for communications between communicating entities. When an HTTP connection is established between a web browser and a web server, it is typically established using specific TCP port numbers, such as TCP port number 80. As such, most filtering systems are configured to allow TCP connections on Port 80 (for HTTP) and Port 443 (for HTTPS) to pass in one or both directions. Future protocol variants of HTTP may require additional ports and as such this invention covers any additional protocol modifications that would include additional ports or protocol variants. Thus, it is important for web-based applications and services to utilize the standard or common ports for communications so as not to be blocked by intermediate filtering systems existing in the path between the communicating entities.

In the following discussion, the limitation of standard browser based applications to efficiently receive real-time updates is illustrated. The invention described herein does not require end user computers to contain additional software components (e.g., plug-ins, ActiveX controls) other than that which is obtained with a standard browser. Furthermore, it does not require the use of software component controls that may be automatically downloaded from the web server when the web page is hit (e.g., Java Applets, ActiveX controls). The invention includes for real-time messaging over the Internet without requiring such problematic, inefficient and costly mechanisms. The improvements of the invention are contrasted with the problematic state of current technology by first describing the limitations or inefficiencies of current technology.

In a typical HTTP protocol based interaction between a standard web browser and the web server, the web browser may send a request message to the web server as a result of some action by the user or a program executing on the end user computer. FIG. 1 shows request message 200 being sent from the end user computer 110's web browser to the web server 101. For the purposes of this invention, a web server minimally contains an HTTP protocol stack supporting HTTP or its variant protocols. The web server (101) may carryout some processing and immediately sends a reply message back to the end user's web browser at computer 110. The reply is only sent in response to the request. If a request is not sent by the web browser on the end user's computer (110) to the web server, the web server (101) is not able to send a reply message to the web browser. The invention described herein includes a method by which the web server may receive a request from the web browser, but not necessarily immediately reply to the web browser until an event or change in state has occurred in the web server. Subsequently, the web server may send one or more messages to the web browser if and when there are messages in the server that are ready to be delivered to the web browser. Furthermore, the system can operate using standard web protocols over standard port numbers and thus can typically pass through filtering systems.

Given the current state of Internet technology, the ability for a web server to deliver messages to the browser in real-time is possible, but requires the use of technology solutions that are often problematic, inefficient or inconvenient. Developers have several choices, each with their own inefficiencies or problems, with respect to building Internet-based technology that allows for web servers to instantly send messages to the browser container. Some example solutions include:

1. Java Applet or Program: Building a Java applet or Java program that executes within the browser. The Java Applet establishes a connection to the server, and can send and receive messages from the server. Java Applets are compiled components.

2. Smart pull (polling): The client contains code that periodically polls the server for any new messages. If messages are found during the polling that are destined for the client, the client pulls the messages to the browser.

3. ActiveX controls—an add-on software component that is installed or located on the machine containing the browser, and that acts similarly like the Java example above. ActiveX controls are compiled components.

4. Other extra components or software modules: software components that are downloaded or installed on the end user machine where the browser resides and that are used to communicate with the web server or other machines, e.g. plugins, browser extensions, installed programs.

Each of these solutions has some significant disadvantages. Java applications and ActiveX controls, or other installable components require client side maintenance. That is code must be installed on the client machine and maintained. As new versions of the code are created, they must be redistributed and installed on the client machines. These activities have been shown to be costly in terms of resources used to distribute and install new versions of the software (high total cost of ownership). Users may be reluctant to install software on their machines because it is inconvenient and has the potential to damage their computer system or they may not trust the source of the software. As new versions of the component or software become available, the user is often required to upgrade to the new version. The software components that must be downloaded and installed on the user machine are often large and may take a significant amount of time to download if the user is connected to the network via a low speed dial-up connection. Furthermore, many filtering systems will not permit such controls to pass during the download phase in order to prevent users from potentially installing software that may be un-trusted and does damage to the computer, systems, network or other facilities.

Smart Pull or Polling is inefficient because the client browsers poll the server periodically, thus loading the server Central Processing Unit (CPU), to find out if a message is ready to be pulled from the server to the client. If thousands of clients are polling periodically to the server, the computational loading on the server can be severally impacted as the number of clients increases and the polling interval increasing. If it is important to provide real-time message delivery, then the polling rate is increased, thus further increasing the server load. Polling produces less real-time message delivery because there is always a waiting period between each polling event. If a message arrives at the server just after a polling event, the message cannot be pulled to the end user's browser until the next polling event, thus causing a delay in message delivery to the end user.

Java applets are control components (control components are compiled) and that are automatically downloaded from the server when the server Universal Resource Locator (URL) page is hit. Similarly, ActiveX control components and can be automatically downloaded when a page is hit. For the purposes of this invention, we use the notion of control component to mean a compiled component or object. A URL uniquely identifies a web page. Java applets and ActiveX controls, however, are often not permitted to pass through security filtering systems (e.g., firewalls). Thus, this does not provide a ubiquitous solution. Furthermore, Java applets often have Graphical User Interface (GUI) components associated with them to render the received messages in the browser. The current Java GUI technology does not often render consistently across different browser versions and brands. Finally, Java applets may make TCP connection types to the server using non-standard TCP ports and as such may be blocked by the filtering systems from making the connections.

To illustrate further the limitations of current day solutions, several available web based messaging offerings are described.

Yahoo, and America Online (AOL) and Microsoft offer an “instant messaging” service that allows Internet users to send messages to each other sent from the sender's browser and received to the recipient's browser. The messages typically travel from the originating user's browser to the web server that then forwards the message to the destination user's browser, providing the destination user's browser is enabled and the user is logged into the service.

To enable instant messaging using the Yahoo service, the communicating entities must first download a software component and install it on the user's computer. If the user's desktop does not permit ActiveX controls or Java applets to be run, then Instant Messaging is implemented via polling (smart pull). That is, the recipient's browser polls the server periodically to determine if a new message is available. If so, the message is pulled to the recipient's browser. The downloaded code is over 1 Megabyte in size. Furthermore, the components often establish TCP connections on non-standard ports and thus may not pass through filtering systems.

Microsoft's version of instant messaging on the Internet requires the client to establish several TCP connections to the server using port number 1863 on the server. Thus, the clients do not connect to the server via HTTP Port 80, which can causes difficulties in passing the connections through filtering systems. Furthermore, to use the Microsoft Instant Messaging service requires the installation of Microsoft Messaging software on the client machines.

The invention includes but is not limited to a system and method for real-time communication between any entities that use the HTTP protocol or its variants, or any protocol type. Thus, the invention includes but is not limited to a system and method for web server to web server real-time communications. As is the case in web server to web browser real-time communications, passing through filtering systems is important to provide ubiquitous service. Web servers often need to communicate with each other to provide real-time electronic commerce (e-commerce) business-to-business communications. Business-to-business e-commerce is estimated to make up a disproportionately large portion of the commerce on the Internet in the next few years. Business-to-business e-commerce is often carried-out between web servers. Furthermore, real-time communications can be critical to the e-commerce market place. The invention includes a system for real-time communications that can be utilized by web server carrying-out business-to-business electronic commerce. Since the invention includes the use of the HTTP protocol and its variants, it allows for communicating web servers to carryout e-commerce communications through filtering systems without requiring specialized configurations. The invention can be used in many applications that require real-time communications using HTTP or its protocol variants or any protocol as the underlying communication protocol. For example, distance learning applications may require the ability for students and trainers to interact in real-time for question and response collaboration interactions. Students may want to type questions to the trainer, who may subsequently desire to response to the questions to one or more students involved in a live training session.

Another application of the invention is for real-time polling. For example, in distance learning applications, trainers may wish to pose one or more questions to (poll, meaning “pose a question to and expect a response”) the students during a training session, by providing a question to the students and soliciting immediate response from the students. Alternatively, the system can support real-time election results where users are solicited to vote for one or more candidates, and the voting results are collected and displayed to one or more poll initiators or anyone in real-time, as the voters provide their results.

Another application of the invention is for live, remote product marketing and demonstration. In this application, a marketing or sales person (Presenter) may wish to remotely navigate one or more customers through a document, slide show, illustrating a new product or service. In this case, the marketer may desire to cause the web browser pages to flip at one or more customers' web browsers during a live demonstration. Thus, the invention can be used by the Presenter to cause page flip messages to be sent to the remote user's web browser in real-time using the http protocol type to transport the messages. The Presenter may be utilizing the telephone to communicate with the remote users, to provide verbal descriptions during the presentation. The page flips may occur in synchronization with the verbal queues provided by the Presenter.

Another application of the invention is for group membership, where as members of the group arrive or depart, one or more monitoring users are immediately notified of the membership change or the state of the group membership. Thus the monitoring users can instantly know what members are participating in a group at any given instant. For example, during a live training session, it may be important for the trainer to immediately be notified when students leave or join the training session, or have been disconnected due to connectivity failure. Real-time group membership is important if the members of the group are to be provided with a quality of service guarantees. That is, the trainer needs to be informed immediately of group membership changes.

Another application of the invention is for alert notification. An Alert Monitor (one or more users or computers) may desire to be alerted in real-time of status changes of any process or event occurring. Events may be generated and reported to the event mediator. The event mediator coordinates the requests and response messages of senders and receivers. The event mediator can provide the events to one or more Alert Monitors in real-time.

Another application of the invention is a real-time annotation system wherein a trainer or presenter (leader) in a distance learning, web seminar or other similar type application may annotate a web page view by, for example, drawing on the page, highlighting items on the page, much like the type of features obtained from a white board application, such as that provided by Microsoft NetMeeting, version 3.01. The annotations that are made by the leader are then sent in real-time to the attendees are students (recipients) resulting in the same annotations being drawn or displayed at the recipients web page view. The recipients may also act as leaders.

Another application of the invention is a follow-me browsing whereby the leader may lead a set of recipients on a tour of the web or other such medium. That is, the leader may push Internet pages to the recipients such that the recipients see the web pages specified by the leader for the duration specified by the leader. Additionally, as the leader navigates his local view, the recipients may see the same pages as the leader does, as the leader navigates. Thus, the recipients may be brought on a tour of the Internet, for example, lead by the leader.

Other applications of the invention include Instant Messaging, chat, discussion groups, and email notification. All such applications can be implemented using the immediate messaging invention described herein.

Again, these applications utilize the real-time messaging system and reap the benefits of it, such as operation through filtering systems, including the user of standard HTTP protocol or its variants with no need for downloaded or installed components on the browser to obtain real-time messages, more efficient and rapid real-time message delivery as compared to periodically polling the server.

### SUMMARY OF THE INVENTION

The HTTP protocol and its variants have been instrumental in the success of web-based communications. However, they have some limitations that have made them inefficient or incapable of providing real-time messaging, as compared to classical client/server communications. For example, HTTP utilizes the TCP protocol for communications. HTTP always requires that the TCP connection be initiated by the client (browser) to the web server. Furthermore, the request message is most always initiated by the client (browser) and not initiated by the server. In classic client/server communications, the server can initiated messages to the client, without necessarily first obtaining a request from the client.

In early versions of HTTP, the connection established by the client to the server was not persistent. Every request and response interaction between the client and server required that a separate TCP connection be established and tom-down, after the response was received by the client. The HTTP protocol has subsequently been modified to provide some degree of persistence. For example, when a browser initiates an HTTP connection to a server, the connection may not immediately be torn-down after the web server responds to the request. The browser may leave to connection active for another request/response interaction to the same web server. If the client does not initiate the request within some timeout period, the connection may be torn-down.

The invention includes application to the HTTP protocol and all of its variants. The invention furthermore includes the application to any protocol in which the client always initiates the request/response interaction with the server and where the server may not deliver a response message to the client without first receiving a request from the client. While the invention is described in terms of the HTTP protocol and its variants, the invention is applicable to any protocols that meet these criteria.

The invention includes a system and method by which communicating entities using any communication protocol, including but not limited to the HTTP protocol or its variants, may send and receive messages in real-time. The method may utilize the HTTP protocol and any derivations of the protocol, to carry the messages and as such, can utilize standard TCP ports numbers that enables it to easily pass through filtering systems, providing ubiquitous real-time message delivery. The invention includes real-time messaging between web browsers and web servers, web servers and web servers, and any communicating entities that use the HTTP protocol or its variants for communications.

The system and method described herein includes real-time messaging between a standard browser, coordinated with software operating on the web server (server side logic) to instantaneously deliver messages from the web server to the browser whenever the messages are available for delivery at the server. The invention herein includes a method that does not require additional components or executables to be installed in the client machine, other than that obtained with a standard web browser. The invention does not utilize polling (smart pull) and is thus more efficient and provides for faster real-time message delivery, as opposed to what can be accomplished using polling techniques. The invention does not require the web browser to poll for state changes in the web server, nor utilizes any end user installed software component such as ActiveX controls, or other such client installed software components. Finally, the invention can, but is not restricted to use, standard web protocols and thus can pass though filtering systems. Thus, the invention includes a lightweight (zero foot print at the client), real-time messaging system between web servers and web browsers that is significantly more efficient than polling, provides more rapid message delivery compared to polling, and provides for ubiquitous use because it does not require additional components to be installed, nor Java applets, ActiveX controls or compiled controls of any sort, and utilizes the HTTP protocol which can pass through filtering systems.

An overview of the real-time messaging invention is described herein, as shown in FIG. 2 using as an example, the http protocol as the underlying communication protocol. The system requires at least one server, the event mediator component (which may or may not be co-located with the server), and one or more communicating entities. The event mediator is the entity that coordinates the client requests and response messages that enables one-to-one, one-to-many and many-to-many messaging over communication channels. All entities that desire to receive real-time messages must first be associated with an event identifier managed by the event mediator, by submitting a request-for-identified-event message to the web server, which forwards it to the event mediator. An event identifier identifies a channel of communication on which senders and receivers may send and receive information, respectively. That is, senders may send information on a given communication channel, and receivers may receive information on the communication channel. A communication channel may be identified by an event identifier. Event identifiers should be unique so as to allow communications between the intended group of senders and receiver communicating entities. Senders and receivers may provide the event identifier when sending or receiving information, respectively. The request-for-identified-event message may be included with an HTTP “post” or HTTP “get” message type. The post or get HTTP may not complete, but remain outstanding at the web server.

An entity may send a message to the web server, specifying an event identifier to identify the communication channel. The web browser sends the message to the web server, which forwards it to the event mediator. The event mediator receives the message from the web server and may forward the message to one or more web browsers associated with the event identifier, by allowing for the completion of the previously submitted HTTP post or get. After the recipient entity or entities receive the message, they may immediately send another request-for-identified-event message to the web server, in preparation for receiving future messages. The originating entity may or may not also be a recipient. The senders, receivers, server or event mediator may be co-located or not, with respect to each other.

The invention is novel in that it includes the capability to provide for real-time communications by having the receivers initiate a request to the server, irrespective of whether there is data available at the server for the receiver. The server may hold-up the completion of the receiver's request, not allowing it to complete, if there is no data available at the server for the receiver. When, however, a sender sends a message to the server that is destined for the receiver, the previously issued receiver request that is outstanding at the server is allowed to complete and the data provided by the sender to the server is provided as payload during the completion of the receiver's request. If more than one data item is available at the server and is destined for the receiver, the server may allow completion of the previously issued receiver request, providing all data items destined for the receiver as message payload. The invention works for one-to-one communications between a sender and receiver, for one-to-many communications between a sender and many receivers, and for many-to-many communications between many senders and many receivers. Note that a user may act as both a sender and receiver. This invention is very important in that it can provide for real-time messaging for HTTP type protocol interactions, as is explained below.

Typically, when a web browser interacts with a web server, the web browser initiates an HTTP connection to the web server (connect-up). Web based communications are problematic to establish when it is required that the web server initiate the connection to the web browser (connect-down). For example, connect-down from a web server to a web browser through filtering systems may not be possible because the filtering systems (e.g., proxy servers) may hide the IP address of the destination web browser's computer. The invention described herein includes a real-time messaging system that does not require a connect-down from the web server to the web browser, and thus is able to provide efficient real-time messaging through such filtering systems.

The invention is generalized to include real-time communications between any two or more entities that may include the use of the HTTP protocol, any of its variants or any protocol for communications. In the case of HTTP, or any of its variants, at least one of the entities may be a web server or acts as an intermediary between the communicating entities, along with the event mediator component. For example, a system where real-time messaging occurs between different end user web browsers can be established. In FIG. 1, the user at computer 110 may want to send a message to the user at computer 112. Alternatively, the event mediator component may include an HTTP protocol stack and thus not require a web server for client server interactions.

The user's browser at computer 110 sends the message to web server 101. In this configuration, we assume that the event mediator component is co-located with the web server (101). In general, the event mediator component may be located on any machine and is not required to be co-located with the web server. The event mediator co-located at Web server 101 (in this example) extracts the event identifier from the message and determines that the message should be sent to the browser at computer 112. The web server (101) sends the message in real-time to the browser at computer 112. If more than one message is ready to be sent to the receiver at computer 112, the event mediator may send all message destine for compute 112 in one interaction. If a sender has multiple messages to be sent to different users or groups of users that are using different event identifiers, the messages may be combine in one interaction and the server may deliver the messages to the appropriate receivers using their respective event identifiers. If more than one message is destine for a receiver that is listening on more than one event identifier (sent a request-for-identified-event interaction for multiple event identifiers, or sent multiple request-for-identified-event for each event identifier), then the messages may be delivered to the receiver in one interaction, and the receiver may de-multiplex the messages based on their event identifiers.

Thus, the invention described herein includes a system that mitigates real-time communications between web users, such that any user may send a real-time message to one or more users using any protocol, including but not limited to HTTP, and its variants, as the underlying communications mechanism. The system includes but is not limited to one-to-one, one-to-many or many-to-many communications using event identifiers to distinguish groupings of communicating parties.

Real-time messaging may be utilized between two web servers. The invention provides the same benefits as those listed above for web browser and web server real-time messaging communications. For example, the two communicating web servers would not need to poll each other to obtain messages. The communications would pass through filtering system because the communications would operate using the HTTP protocol or its variants. Thus, the invention is generalized to include communications between parties that use the HTTP protocol or any of its variants for communications.

The invention herein includes an application of the real-time messaging system to provide an Interactive Question and Answer (IQ&A) service. This IQ&A service providers for one-to-one, one-to-many and many-to-many real-time messaging using the HTTP protocol or its variants. A typical application of the IQ&A service is for communications between students and teachers that are remotely distributed from each other, such as for use in live Internet based training. Students may type one or more questions that are delivered to the trainer. The trainer may read the question, decide to ignore it, or decide to reply to it and as such type a response to the question(s). The trainer may send the question(s) back to the requesting student or may send the question(s) along with response(s) to all or some subset of students participating in the training. IQ&A provides for one-to-one or one-to many communications where all communications are between the students and trainer. The trainer acts as the intermediary to allow the question and/or response to be displayed to one or more students. This is in contrast to “chat” where all communications are displayed to all participants of the chat session. The invention still can be used to implement chat, providing all of the features of the real-time messaging system. Communications for the IQ&A application of the real-time messaging system invention are carried over the HTTP protocol and its variants. The IQ&A application may provide many-to-many interactions when there are multiple trainers responding to questions to the same set of students. That is, the multiple trainers (multiple senders) may respond to various questions or the same question, providing different opinions, for example.

The invention herein includes an application of the real-time messaging system to provide for real-time polling. The application utilizes the real-time messaging system to allow a Poll Initiator to pose a question to one or more users that may be remotely located from the Poll Initiator. The remote users may immediately receive the posed question or set of questions, and respond to the question(s). A Polling Service located at the web server or in the server infrastructure, may aggregate the responses in real-time and provides the aggregated results to the poll initiator as poll results are compiled in real-time. Alternatively the individual responses may be provided to the one or more Poll Initiators, which may or may not subsequently aggregate the results. The polling results may also be stored for future reference at the server back-end or at the Poll Initiator's computer.

The invention herein includes an application of the real-time messaging system to provide for remote web page flipping. The system uses the real-time messaging system to allow a user's web browser (Presenter) to cause remote user web page flips to occur at one or more remote web browsers (recipients). The Presenters flip the web page at their own browser. A page flip message is sent to the web server and is associated with a specific event identifier that correlates the Presenter with the recipients. The web server forwards in real-time the page flip message(s) to all browsers that have expressed interest in the event identifier (recipients). The recipient's browser flips to display the new web page. The page flip message is sent from the web server to the recipient's browser using the real-time messaging system. The page flip message sent from the presenter to the recipients via the event mediator may include the actual page information itself, or simply the URL of the page. If the message contains the URL of the page, the recipient's browser may receive the URL and navigate to the URL, thus causing the page flip to occur at all recipient browsers. Other page flip information may be contained in the page flip message in addition to web pages or URLs.

The invention herein includes an application of the real-time messaging system to provide for real-time Group Membership. Group Membership allows users to join and leave groups. As users do so, a Monitor application, system or user may be informed, using the real-time messaging system, of changes in the state of the group. Furthermore, members of the group may periodically provide a liveness indication to the Monitor, indicating that the member has connectivity to the Monitor. If the member loses connectivity to the Monitor, the Monitor detects that the member has not provided the liveness indication within the predefined periodic interval. Thus, the Monitor obtains group membership changes are rapidly as possible. Alternatively, a Group Membership Service may aggregate membership information at the web server, and present the aggregated results to the Monitor, whenever changes occur in the group membership.

The invention herein includes an application of the real-time messaging system to provide for a real-time alert notification. Users or computers may express interest in an event by sending a request-for-identified-event to the event mediator. Such users or computers are called Alert Monitors. Alert notification messages may be provided by any user or computer, by sending a submit-identified-event message to the event mediator. The event mediator notifies the Alert Monitors of the notification message via a response-for-identified-event message.

The invention herein includes but is not limited to applications of the real-time messaging system for providing annotation services, follow-me browsing, instant messaging, chat services, real-time discussion groups, email notification and text based speech. Multiple event mediators may be arranged in flexible configurations so as to provide highly scalable real-time messaging systems for large-scale applications. The arrangement of event mediators and web servers is highly flexible and scalable.

### BRIEF DESCRIPTION OF THE DRAWINGS

In the following text and drawings, wherein similar reference numerals denote similar elements throughout the several views thereof, the present invention is explained with reference to illustrative embodiments.

FIG. 1 is a network diagram showing a typical three-tier web services architecture.

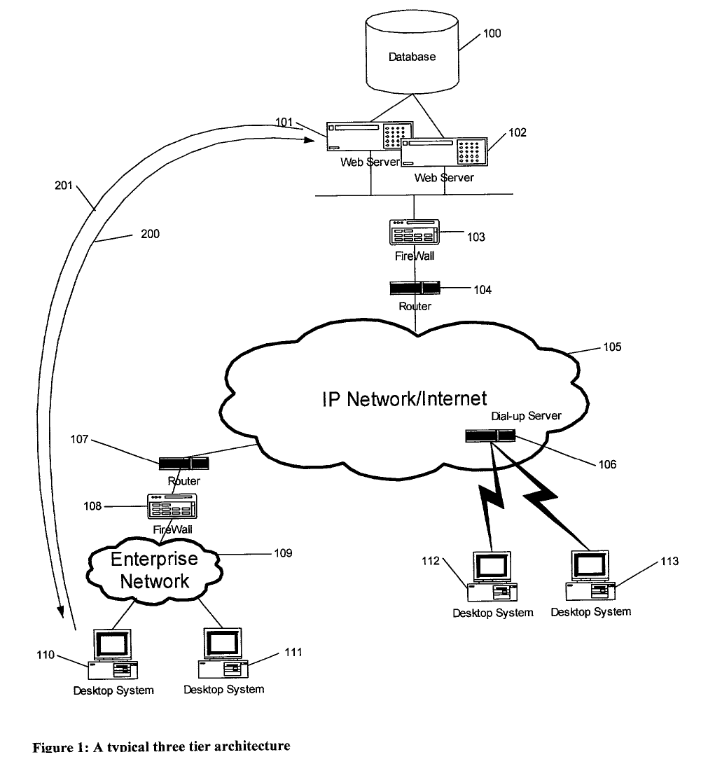

FIG. 2 shows an overview of the protocol message interactions for the real-time messaging system

FIG. 3 illustrates the request for identified event message interaction

FIG. 4 illustrates the submit identified event message interaction with event data

FIG. 5 illustrates the Interactive Question and Answer application

FIG. 6 illustrates the Interactive Question and Answer application with directed communications

FIG. 7: illustration of the Polling application of the invention

FIG. 8: illustration of the Page Flip application of the invention

FIG. 9: illustration of the Group Membership application of the invention

FIG. 10: illustration of the Alert notification application of the invention

FIG. 11: Hierarchical arrangement of event mediators in a system

FIG. 12: Graphical arrangement of a system of event mediators

FIG. 13: Event mediator service models

### DETAILED DESCRIPTION OF THE PREFERRED EMBODIMENTS

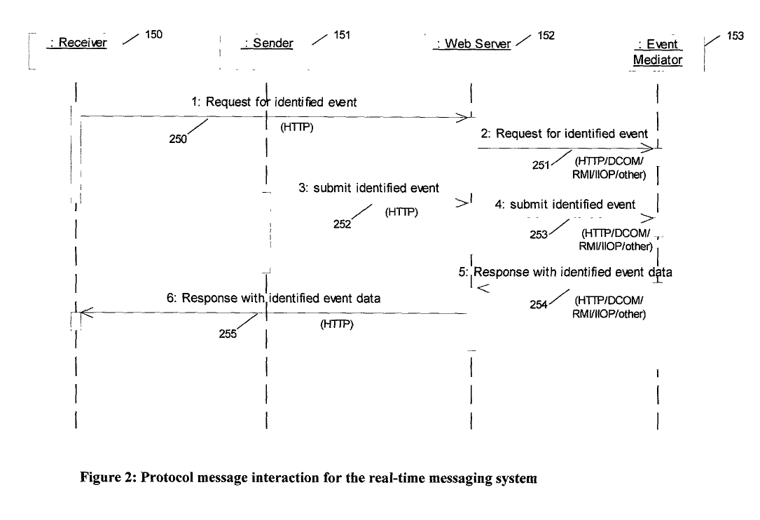

An overview of the real-time messaging system is shown in FIG. 2, and is described by identifying various roles and components. The diagram shows the messages between the sender (151), receiver (150), web server (152) and the event mediator (153). FIG. 2 is a sequence diagram and assumes that time lapses downward on the vertical axis. The description uses a term “identified event”, which means any event identified by some means, such as a name, number or any kind of identifier. Senders originate messages. Receivers have the potential to receive messages. An entity may act as both the sender and receiver. The real-time messaging system also includes but is not limited an HTTP protocol stack (or its variant protocols), typically included as a component of a web server, and the event mediator component. The examples use, for the most part, the HTTP protocol as the underlying communication protocol. The real-time messaging system operates as follows:

All entities that desire to receive real-time messages must first be associated with an event identifier managed by the event mediator, by submitting a request-for-identified-event message to the web server. The request-for-identified-event message is typically included with an HTTP/HTTPS “post” or “get” message type. The HTTP/HTTPS “post” or “get” does not complete, but remains outstanding. The web server calls the RequestEvent EventMediator Interface method.

FIG. 2 shows that the interaction begins with a request from the receiver to the web server for an identified event (e.g., “course 53”) labeled 250. The request data may be in the form of HTML, XML or in any data representation format. The web server forwards the request to the event mediator via interaction 251. The message may be passed to the event mediator using any messaging system including but not limited to DCOM, RMI/IIOP, HTTP, CORBA, TCP/IP, UDP or any other protocol. The protocol or messaging system between the web server and event mediator is independent of this invention and can be selected based on the implementation and platform preferences.

FIG. 2 shows that the sender (151) of an identified event submits the identified event (e.g., “course 53”) along with any data to the web server via interaction 252. The submit-identified-event message, like the request-for-identified-event message, is typically carried using the HTTP/HTTPS get or post request message. The submit-identified-event data may be in the form of HTML, XML or in any data representation format. The web server forwards the event to the event mediator (153) via interaction 253. The message may be passed to the event mediator using any messaging system including but not limited to DCOM, RMF/IIOP, HTTP, CORBA, TCP/IP, UDP or any other protocol. Again, the protocol or messaging system is independent of this invention and can be selected based on the implementation and platform preferences.

The message format utilized by the event mediator message minimally includes one field, the event identifier. The event identifier may be a number, name, string, any identifier, or any combination of identifiers that is unique amongst all users of a given event mediator. All other fields are defined by the application, are transparent to the event mediator and are considered to be EventData. Receivers of event mediator messages need not have the event identifier contained within the message. However, if the receiver is executing any de-multiplexing base on the event identifier, then the event identifier may be included in messages sent to receivers.

FIG. 2 illustrates that when the event mediator receives an identified event, it matches it with the zero or more receiver outstanding requests for the same identified event (“course 53” in this case). The response for the request in 251 goes back to the web server (254). The event mediator response contains the EventData. The web server sends the corresponding response for the request (250) back to the receiver (255). The web server allows for the completion of the previously submitted and outstanding HTTP/HTTPS post or get requests. After the receiver entity or entities receive the message, they may immediately send another request-for-identified-event message to the web server, in preparation for receiving future messages. The originating entity may or may not also be a recipient.

The sender and receiver interaction with the event mediator is loosely coupled. When a sender submits an identified event, all receivers waiting on the request for the same identified event receive the message. If there are no receivers waiting on the identified event, the message may be discarded by the event mediator or maintained in a queue indefinitely or for some period of time. If at a later time, receivers issue a request-for-identified-event message for the identified event, the event mediator may deliver some or all queue messages to the receiver.

FIG. 2 illustrates a system consisting of web-based receivers and senders. In the preferred embodiment, the senders and receivers interact with the web server using the HTTP protocol or variants of the protocol. In an alternative embodiment, the invention includes non-web based senders and receivers or any combination of the web based and non-web based senders and receivers. To clarify further, in a given scenario there can be multiple web and non-web based receiver and senders for multiple identified events in any arbitrary combination.

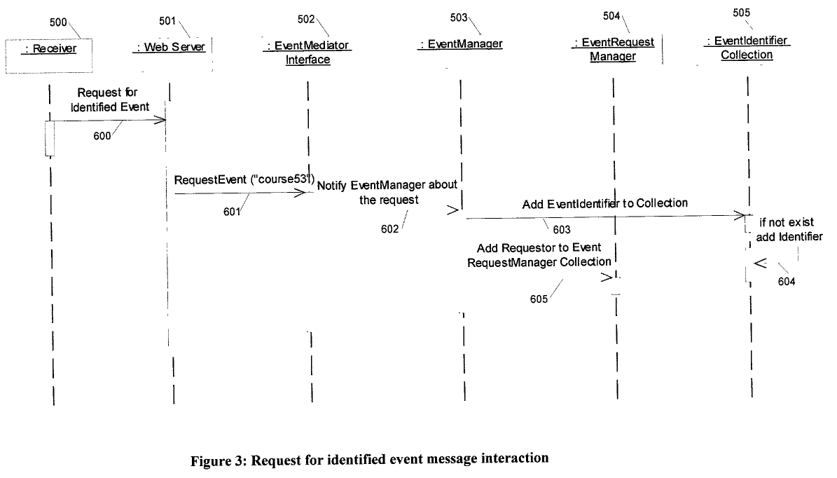

FIG. 3 shows that the event mediator may consist of several subcomponents including the EventMediator Interface (502), EventManager (503), EventRequestManager (504), EventIdentifier Collection (505). The event identifier and EventData in the preferred embodiment are data types based on the String type, but may be of any type. The EventMediator Interface includes an interface to the web server. It may provide the RequestEvent, FireEvent, and GetHistory methods. The EventRequest Manager may maintain the pool of outstanding requests for identified events used in correlating previously submitted request-for-identified-event requests with responses for the given event identifier. The EventIdentifer Collection may maintain a collection of the event identifiers being managed by this instance of the event mediator. In this invention, several event manager instances may but are not required to use the same Eventldentifer Collection. The collections utilized by the event mediator may be implemented has heaps, link lists, hashed tables, b-trees or any data structure. The event mediator internal data structures, message formats, and or application programming interfaces as well as other aspects of the implementation may also be implemented in XML.

When a receiver (500) sends a request-for-identified-event message (600) to the web server (501), the web server may call the RequestEvent EventMediator Interface method (601), specifying the event identifier (in this case “course 53”). The EventMediator Interface (502) may notify the EventManager (503) about the request. The EventManager component may check if the event exists in the EventIdentifier Collection (505) via interaction 603. If the event identifier is not a member of the EventIdentifier Collection, it may add the event identifier to the collection (604). Otherwise, it may not add the member to the collection. The EventManager may then add the requester to the EventRequest Manager Collection (504) and may increments a reference count. The reference count may be incremented for each request-for-identified-event received by the event mediator. The reference count may be used by the EventManager to determine when an EventData item may be discarded, because all outstanding request-for-identified-event requests have been serviced. That is, when the reference count for a particular EventData item reaches zero, then the EventData buffer space used at the EventRequest Manager Collection may be garbage collected. The invention includes but is not limited to using a reference count for triggering garbage collection of EventData messages.

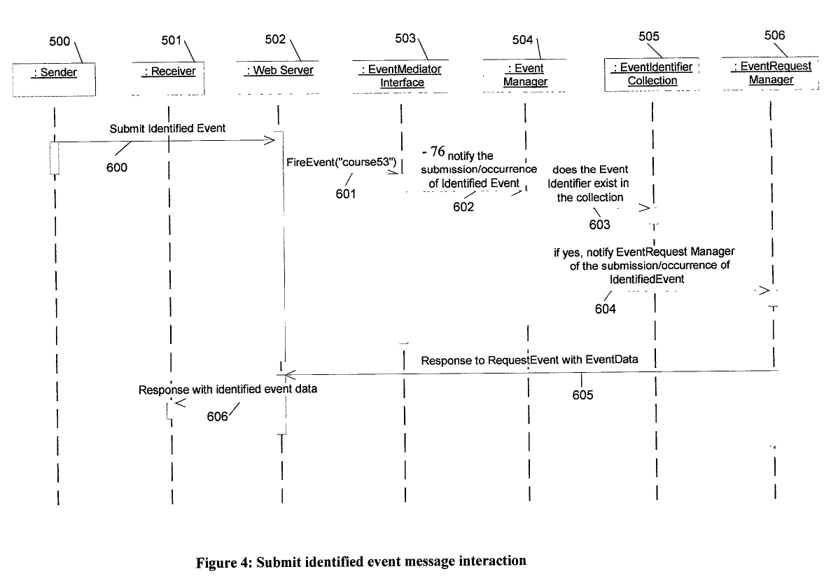

FIG. 4 shows the submit identified event process. When an entity acting as a sender (500) sends a submit-identified-event message (600) to the web server (502), specifying an event identifier in a submit-identified-event message, along with the message data (EventData), the web server (502) may call the FireEvent EventMediator Interface method (601) with the message data provided as an argument to the method call. The EventMediator Interface (503) may notify the EventManager of the submission or occurrence of the identified event (602). The EventManager may check if the event identifier exists in the EventIdentifier Collection (505) via interaction 603. If the event identifier exists in the Event Identifier Collection (505), the EventManager (504) may notify the EventRequest Manager of the submission or occurrence of the identified event via interaction 604. The EventRequest Manager may allow for the completion of the one or more outstanding RequestEvent EventMediator Interface method calls for the given event identifier, providing the EventData. Thus, the EventRequest Manager may respond to the web server (502) with the EventData (605) one time for each receiver that had previously submitted a request-for-identified-event for the specified event identifier. The EventRequest Manager's reference count for the identified event may be decremented for each response 605. The web server may allow for the completion of the previously submitted and outstanding HTTP post or get requests. The web server may respond to the one or more receivers with the identified EventData (606). If the reference count reaches zero, the EventRequest Manager may remove the event identifier entry from the collection immediately or after some time-out period. After the receiver entity or entities receive the message, they may immediately send another request-for-identified-event message to the web server, in preparation for receiving future messages. The originating entity may or may not also be a receiver.

During the time that is needed for the receiver to send the next request-for-identified-event message to the web server, in preparation for reception of future real-time messages, some messages may become ready for delivery by the event mediator to the receiver. That is, the event mediator may have had a sender call the FireEvent EventMediator Interface method for the given event identifier prior to the receiver calling the RequestEvent EventMediator Interface method. In this case, the event mediator may buffer data messages for a configurable number of entries or period of time ranging from zero to an unlimited number of entries, or from zero to years period of time respectively. The buffered data may be a function of the combination of space and time. When one or more receivers cause the web server to call the RequestEvent EventMediator Interface method, if messages are contained in the buffer, they are delivered to the receivers. Some receivers may receive the same EventData multiple times.

Filtering may be carried-out within the receivers or web server to eliminate duplicate messages to receivers. In this case, sequence numbers and a unique sender identifier may be added to the submit-identified-event message 600 in FIG. 4. A sender may specify an identifier that uniquely identifies the sender such as a global unique identifier (GUID), unique name, number or combination of any unique identifiers. The sequence number size should be adequate to prevent the sequence number space from wrapping too quickly, e.g., 6 bytes. This can be an application decision and depend on the rate at which messages are sent. These two fields are carried transparently to the event mediator and may be part of the EventData field. The receiver, however, recognizes the sequence number and sender's unique identifier field and can thus filter out duplicate messages. Reliable multicast protocols, for example, require that receivers filter out duplicate messages received at the receiver. Duplicate messages are typically identified by a combination of the source identifier and sequence number. Filtering out of duplicate messages may be carried-out by the receivers, as is typically the case in reliable multicast protocols, or at the server. This capability may be implemented externally with respect to the event mediator system.

If the filtering is provided by the server, then the web server or event mediator may recognize and track the source and sequence number fields associated with messages sent to receivers so as not to send the same message to a given receiver more than once. The web server or event mediator may maintain for each receiver and identified event to which the receiver has submitted a request-for-identified-event in the past, the source identifier and largest sequence number contained in a message sent to the receiver. If after the receiver issues a request-for-identified-event to the web server, a message is ready to be sent to the receiver and the source identifier and sequence number indicates that the message has already been sent to the receiver, the message is not sent to the specific receiver. Otherwise, the message is sent to the receiver and the latest sequence number contained in the message sent to the receiver is noted by the web server or event mediator and associated with the receiver. In this alternative design, the source and sequence number is not transparent to the web server or event mediator.

The real-time messaging system delivers messages to recipients when messages are originated, such as may occur during live communications. If a sender sends a submit-identified-event data message to the web server and no other entities have sent a request-for-identified-event message to the web server, then the sender's messages may be discarded. In an alternative embodiment, the message may be stored and when a receiver sends a request-for-identified-event message, all previously stored messages or some part of previously stored messages may first be provided to the user. This feature is called durability. That is, when a receiver is disconnected, off-line or has lost connectivity to the server, or has not sent a request-for-identified-event message for some time, and then does so, all messages that have been missed during the period of disconnection may be sent to the receiver, allowing the receiver to “catch-up” or resynchronize. This feature can be useful in applications where it is important that the receivers do not loose some portion or all messages. Note that the amount of durability provided by the server can be parameterized and tuned and may be a function of time (duration with which durability is required for the application, e.g. the last 2 minutes) and or space (memory capacity of the server, e.g., the last 2 kilobytes or last 10 messages) constraints. If sequence numbers are associated with EventData, then the receiver may provide a sequence number from its last received message, that indicates to the server what EventData messages the receiver needs to become resynchronized with. Many schemes existing in prior art may be used to resynchronize the receivers, including schemes related to reliable multicast delivery. The event mediator or other entity may store some portion, none of or all messages. When a recipient sends a request-for-identified-event message to the web server, the stored messages may first be delivered to the recipient. Thus, the invention may include persistent or transient queues incorporated with the real-time messaging system. The real-time messaging with queues is a variation on the prefer embodiment and is described as follows:

As shown in FIG. 2, a receiver (150) sends a request-for-identified-event message (250) to the web server (152). In the preferred embodiment, the receiver need only include the event identifier in the request. In the real-time messaging system with queues variation of the preferred embodiment, the receiver may also include an identifier that uniquely identifies the receiver. For example, an email address of the user, a global unique identifier (GUID), a userid, or any such mechanism can be used to uniquely identify users. The web server (152) sends the request-for-identified-event message to the event mediator, including the receiver's unique identifier. More specifically as is shown in FIG. 3, the web server (501) calls the EventMediator Interface (502) method RequestEvent. However, in this case, the RequestEvent method additionally includes the receiver's unique identifier as an argument. The EventMediator Interface (502) notifies the EventManager (503) in interaction 602, again including the receiver's unique identifier. The EventManager may add the event identifier to the EventIdentifier Collection (505) via interaction 603, as is done in the preferred embodiment. The EventManager then adds the requestor to the RequestManager Collection (504) via interaction 605. The method call represented by interaction 605 includes the receiver's unique identifier. The EventRequest Manager adds the request associated with the receiver's unique identifier. Again, the collection may be implemented using many structure types such as a linked list, heap, b-trees, or hash table.

In FIG. 4, the submit-identified-event message sent by the sender (500) to the web server (502) does not require change to operate with the queue enabled real-time messaging variant of the preferred embodiment. The system requires change in the EventRequest Manager (506) and the responses 605 and 606. When the Event Manager (504) notifies the EventRequest Manager of the submission or occurrence of and identified event (604), the EventRequest Manager may send the Response (605) to each receiver that has an outstanding request in the collection. The EventRequest Manager may track which receivers have been responded to for each EventData. The EventRequest manager may track its responses to receivers using many techniques including but not limited to maintaining a separate persistent or transient message queues for each receiver or potential receiver, or assigning unique sequence numbers for each EventData item to the message when it arrives at the web server or event mediator and then tracking for each receiver the sequence numbers of messages that have been sent to each receiver and thus determining which messages still need to be sent to each receiver. If an outstanding request is not present for a receiver that is in the collection, then the EventData may be stored for a configurable time period, which can be anywhere from 0 seconds to years. The time period may determine the level of persistence required by the application. Thus, in this variant of the preferred embodiment, receiver's unique identifiers are maintained or referenced by the EventRequest Manager even if no requests for identified events are outstanding in the EventRequest Manager. The unique identifiers may be stored in a directory server, database or other such storage facility.

A receiver may have previously interacted with the system, such that the EventRequest Manager has identified the receiver, but no outstanding request for identified event is currently present at the event mediator for that receiver. If or when the receiver sends a request-for-identified-event to the web server, including its receiver unique identifier along with the identified event, the process stated above may occur. Referring to FIG. 3, when the EventManager (503) adds the request to the EventRequest Manager Collection (504) in interaction 605, the EventRequest Manager first checks to see if there are any messages pending to be delivered to the specific receiver identified by the receiver's unique identifier. If so, then referring to FIG. 4, the EventRequest Manager may immediately respond to the web server (502) via interaction 605 with the pending EventData that has been buffered for this receiver. The receiver may immediately submit to the web server a request-for-identified-event message to be ready to receive any new messages.

An alternative method by which a receiver may retrieve any outstanding messages that have been buffered is to have the receiver explicitly send a new message type, request-for-identified-event message-get-history. In FIG. 3, instead of the receiver sending message 600, the receiver would replace message 600 with the request-for-identified-event message-get-history message which would cause the web server (501) to invoke the EventMediator Interface method GetHistory, passing the receiver unique identifier as an argument. In this case, the system operates as specified above, allowing the EventRequest Manager to immediately respond to the receiver with any queued data. The request-for-identified-event-get-history message allows the receiver to explicitly and immediately request all buffered or history EventData to be delivered to the receiver. This method may be used in conjunction with message sequence numbers so that the receivers may determine if any messages received as a result of a request-for-identified-event-get-history request are duplicate and discard them appropriately. For example, if sequence numbers incorporated in the EventData by the senders, then the receivers that want to resynchronize may specify the last received sequence number in the request-for-identified-event-get-history thus indicating to the server which messages are needed. Again, these techniques are found in prior art related to reliable multicast and unicast protocols.

As stated above, the Interactive Question and Answer (IQ&A) is an application of the real-time messaging system and allows, for example, students and trainers to communicate questions and responses to each other in real-time for distance learning applications where the students and trainers may be remotely located with respect to each other.

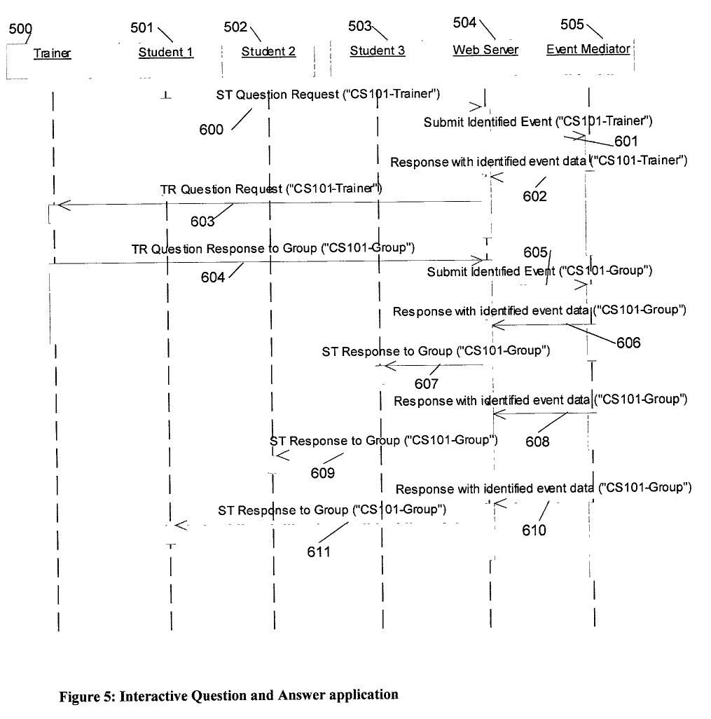

The IQ&A service is an application of the real-time messaging system invention. The IQ&A service is illustrated in FIG. 5 and operates as follows: When the student (501) types a question, and possibly clicks a button to submit the question, the text is sent to a web server in message flow 600. The message flow consists of a submit-identified-event message with additional fields specified in the EventData. For example, accompanied by the message may be an identifier that uniquely identifies the student. Other information of any kind may be included along with the message, such as the event identifier associated with the trainer. The event identifier is the “CS101-Trainer” in this example. An XML representation of the format may be but is not limited to the following:

<message>
<eventIdentifier>CS101-Trainer</eventIdentifier>
<eventData>

<originatorIdentifier>JohnS@yahoo.com</originatorIdentifier>
<originatorAlias>Skywalker</originatorAlias>
<userType>Student</userType>
<interactionType>Question</interactionType>
<body>When is it appropriate to use a link list construct</body>

</eventData>
</message>

The event identifier is used by the event mediator to coordinate requests and responses. All other fields are considered to be EventData by the event mediator. The other fields are interpreted by the IQ&A application, an application of the invention.

The web server (504) receives the message, interacts with the event mediator (505) via interaction 601. The event mediator responds to the web server via interaction 602, which then forwards the message to the trainer's web browser via interaction 603. We assume that the trainer had already sent a request-for-identified-event to the web server for event identifier “CS101-Trainer”. Furthermore, throughout this discussion we assume one or more trainers may exist. Thus, a student's question may be sent to one or more trainers.

The trainer may ignore the question. In this case, the message interplay for this message may be terminated. The trainer may respond to the group of students participating in the IQ&A session by submitting a submit-identified-event message for event identifier “CS101-Group” to the web server (504) via interaction 604. The XML format of the message may be but is not limited the following:

<message>
<eventIdentifier>CS101-Group</eventIdentifier>
<eventData>

<originatorIdentifier>JoePhipps@yahoo.com</originatorIdentifier>
<originatorAlias>Your Teacher</originatorAlias>
<userType>Trainer</userType>
<interactionType>Answer</interactionType>
<QuestionBody>When is it appropriate to use a link list

construct</QuestionBody>

<AnswerBody>It is appropriate to use a link list construct whenever
the number of items to be searched is small. </AnswerBody>

</eventData>
</message>

Interactions 605,606, 607, 608, 609, 610, and 611 show the normal mechanism included in the invention for responding to each student with the message, assuming each student had previously submitted a request-for-identified-event for event identifier “CS101-Group”. Each student receivers the question and answer contained in the response message. Thus, the trainer may decide to type a response to the question and/or provide additional information with the response message, and may click a button to submit the response, optionally along with the question, to all students, in this example.

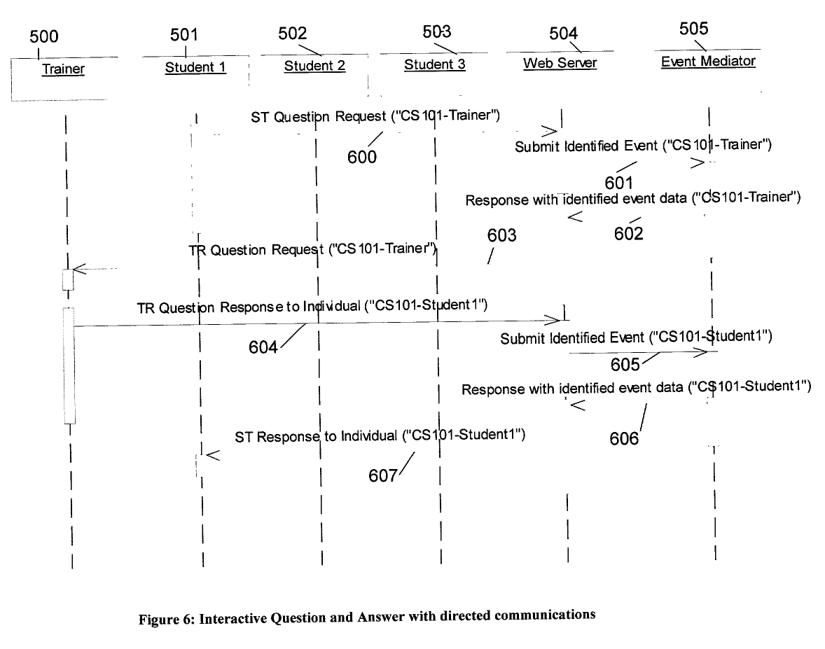

If the requesting student is the only one being responded to, then the response message may be sent from the trainer to the web server and then the event mediator using a different event identifier, which forwards the message to the user's browser, and does so immediately again using the real-time messaging system described in this invention. In FIG. 6, for example, the directed IQ&A interaction is shown. Student 1 (501) sends a question to the trainer (500) as described above and shown in flows 600, 601, 602, and 603. The trainer, however, decides to respond only back to Student 1. Thus, the trainer sends a submit-identified-event message to the web server in interaction 604, specifying “CS101-Student1” as the event identifier. The XML format of the message may be but is not limited to the following:

<message>
<eventIdentifier>CS101-Student1</eventIdentifier>
<eventData>

<originatorIdentifier>JoePhipps@yahoo.com</originatorIdentifier>
<originatorAlias>Your Teacher</originatorAlias>
<userType>Trainer</userType>
<interactionType>DirectedAnswer</interactionType>
<QuestionBody>When is it appropriate to use a link list

construct</QuestionBody>

<AnswerBody>Could you please restate your question in more detail?
</AnswerBody>

</eventData>
</message>

The event mediator and web server subsequently deliver the message to the Student1 as show in interactions 605, 606, and 607.

The trainer may desire to send a message to one, all, or a subset of students. If so, the response message may still sent from trainer to the web server, using an event identifier associated with the target set of recipients to which the message should be forwarded. The determination is done based on the association of users request-for-event-identifier messages outstanding for a given event identifier. For example, a subset of students may send a request-for-event-identifier using a special event identifier only used by the subset of students. Alternatively, the trainer may send the submit-event-identifier message using the same EventData, but different event identifiers, one time for each student to which the message is to be sent. Other systems may be configured to provide one-to-one, one-to-many and many-to-many communications.

The web server cooperating with the event mediator forwards the message(s) individually to each recipient in the set of recipients. Again, all messaging may utilize the HTTP protocol or its variants for communication between all parties and use the real-time messaging system described above. We have described an application of the invention that provides for Interactive Question and Answer potentially used during live training sessions, and subsequently recorded for playback from archived training files. During live training sessions, the trainer may send responses back to one, a subset or all students participating in the session. Students may type questions that are routed to one or more trainers. The IQ&A application is not limited to training applications, but may be used as part of any communication applications. The IQ&A application may additionally be used by itself as a stand-alone application.

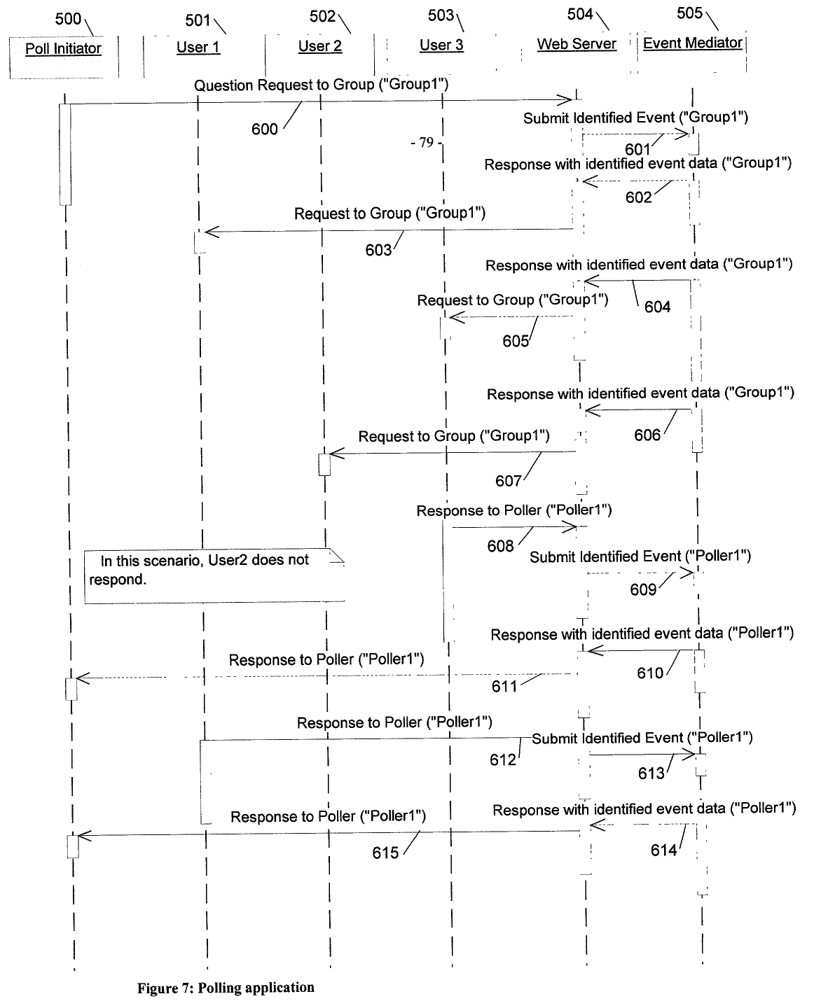

The invention herein includes an application of the real-time messaging system to provide for real-time polling. FIG. 7 shows an example interaction that provides for the polling application. The Poll Initiator (500) sends a submit-identified-event message (600) containing a question request for the users that previously submitted a request-for-identified-event message for the event identifier “Group1”, including User1 (501), User2 (502), and User3 (503). The web server (504) sends the submit Identified Event message to the event mediator (505) shown in flow 601. An XML representation of the message format may be but is not limited to the following:

<message>
<eventIdentifier>Group1</eventIdentifier>
<eventData>

<originatorIdentifier>JohnS@yahoo.com</originatorIdentifier>
<originatorAlias>Skywalker</originatorAlias>
<interactionType>Poll</interactionType>
<pollIdentifer>5467</pollIdentifier>
<body>Who would you vote for for President of the Unitied States
in the 2000 election?</body>
<choice1>Clinton</choice1>
<choice2>Bush</choice2>
<choice3>Gore</choice3>
<choice4>Buchanon</choice4>

</eventData>
</message>

The polling question is delivered to each user by the real-time messaging system, as show in interactions 602 and 603 for User1 (501), interactions 604 and 605 for User3 (503), interactions 606 and 607 for User2 (502).

Next the users have the opportunity to respond to the poll request. Interaction 608 and 609 shows how User 3 responds to the poll request, by specifying the event identifier “Poll1”. It is assumed that the Poll Initiator (500) had previously sent a request-for-identified-event to the web server prior to initiating the poll request (600) for event identifier “Poller1”. The response to the poll request may use, but is not limited, the following XML format:

<message>
<eventIdentifier>Poll1</eventIdentifier>
<eventData>

<originatorIdentifier>User1@yahoo.com</originatorIdentifier>
<originatorAlias>MyAlias</originatorAlias>
<interactionType>Poll</interactionType>
<pollIdentifer>5467</pollIdentifier>
<choice2>Bush</choice2>

</eventData>
</message>

The poll identifier field may uniquely identify each poll request (question). The remainder of FIG. 7 shows that User1 and User 3 respond to the polling request. For example, User3 (503) sends a response to the poll request to the web server (504) via interaction 608. The response is a submit-identified-event type message. The web server interacts with the event mediator 505 to submit the identified event for event identifier “Poller1”. The event mediator responds to the web server via interaction 610, which subsequently provides User3's poll response to the Poll Initiator (500) via interaction 611. The Poll Initiator (500) may issues another request-for-identified-event message (not shown in FIG. 7) for the event identifier “Group 1” after receiving a response to poller (611) so as to be prepared to receive additional responses from the users. In the example in FIG. 7, User2 does not respond to the poll request. The Poll Initiator obtains and tabulates the poll results in real-time. The results may be displayed to the poll initiator user immediately as they arrive at the poll initiator.

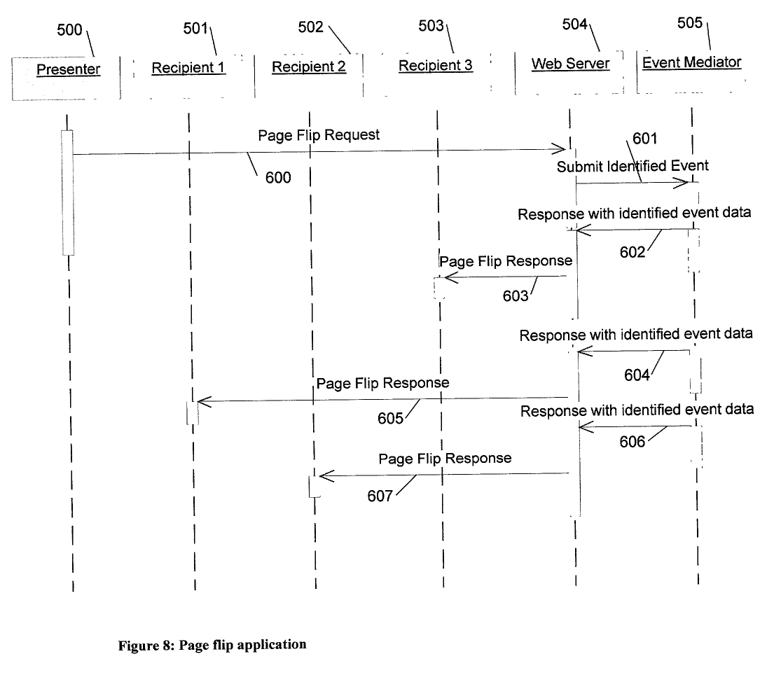

The invention herein includes an application of the real-time messaging system to provide for remote web page flipping. As shown in FIG. 8, the application consists of a Presenter (500) and one or more recipients (501-503). The Presenter (500) may be a person or computer program. The Presenter may be a user of a browser. The Presenter interacts with the browser to cause the browser to send a page flip message to the web server. The page flip request message (600) consists of the submit-identified-event-message, along with the URL of the target web page to which the recipient's browsers should flip. An XML representation of the format may be but is not limited to the following:

<message>
<eventIdentifier>Product X Marketing Session</eventIdentifier>
<eventData>

<targetURL>http://www.myweb.com/ProductXSess1/page34.htm</
targetURL>

</eventData>
</message>

In this example, it is assumed that the recipients have already issued a request-for-identified-event message on an event identifier used for this page flip session (“Product X Marketing Session”). The message travels from the web server to the event mediator as specified in interaction 601 as has been specified in previous descriptions of the real-time messaging system. The event mediator then issues the response-with-identified-data message to the recipients, including the target URL in the EventData field. For example, the event mediator sends the page flip message to the web server (504) via interaction 602 for Recipient 3. The web server sends the page flip response message to Recipient 3 via interaction 603. Likewise, Recipient 1 and Recipient 2 are provided with the page flip response message in message flows 604, 605 and 606, 607, respectively. The remote browsers at the recipients receive the message and then may automatically navigate to the target URL specified in the message. Brower based scripting languages (e.g., JavaScript, Visual Basic script) may be used to implement function that receives the response-with-identified-data message, extracts the target URL and causes the web browser to navigate to the target URL. The target URL may cause the web browser to open a new window to navigate to, or cause a frame within the browser window to navigate to the target URL, or be used to render any view of the target URL as the whole or part of the recipients view, including a hidden view. The target URL may be used in many was by the recipient browser's application. If the page flip application is used by the Presenter during a presentation or web seminar, the Presenter may navigate forward, backwards or skip to different parts of a presentation by simply providing the target URL.

Note that while the example shows the URL being provided to the recipients, and then the recipients navigating to the provided URL, in an alternative method, the actual web page may be provided to the user in the EventData message, rather than the URL. For example, using FIG. 8 again, the Presenter may send a page flip request message (600) as specified above, being processed as shown in flows 601. The event mediator then responds to the web server (504) via flow 602. The web server may at this point retrieve the web page and encode it in the EventData message, which may subsequently be sent to Recipient 3 in flow 603. The Recipient 3 may them immediately display the content of the EventData message in its browser. All recipients may receive the actual data in the EventData message rather than the URL. In another alternative method, the Presenter may place the contents of the entire page in the Page Flip Request message (600) as EventData, thus providing the entire page as payload to be delivered to all recipients.

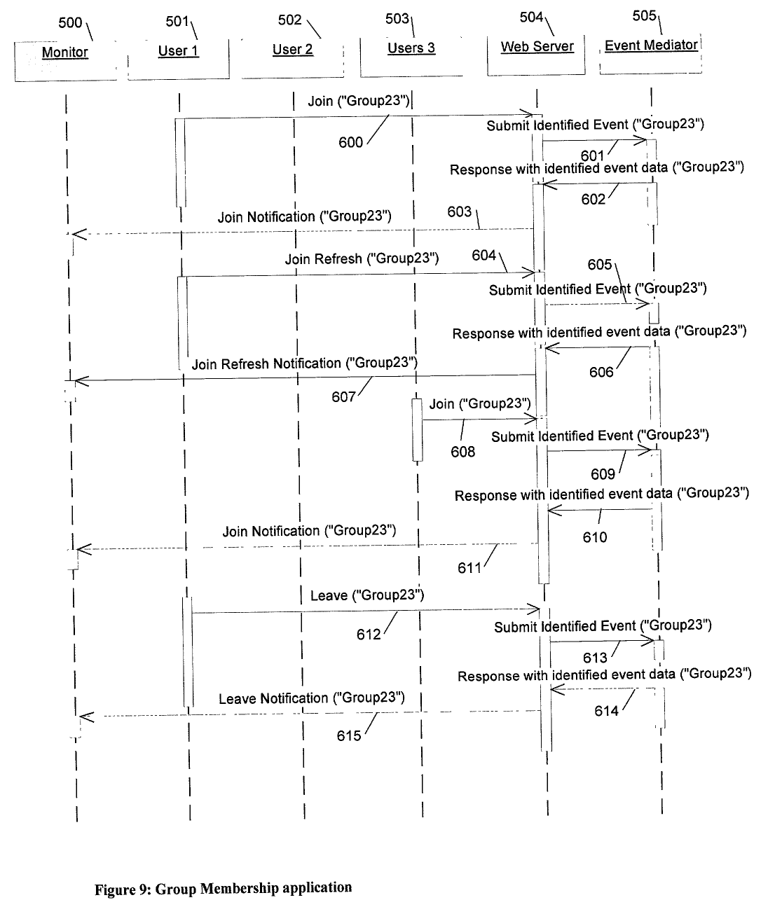

The invention herein includes an application of the real-time messaging system to provide for real-time Group Membership. FIG. 9 shows a system of a single Monitor (500) and several users including User1 (501), User2 (502) and User 3 (503), a web server (504), and an instance of the event mediator (505). Group Membership allows users to immediately join and leave the groups. As users do so, a Monitor entity may be informed, using the real-time messaging system, of changes in the state of the group. Furthermore, members of the group may periodically provide a liveness indication to the Monitor, indicating that the member has connectivity to the Monitor. If the member loses connectivity to the Monitor, the Monitor may detect that the member has not provided the liveness indication within the predefined periodic interval. Thus, the Monitor obtains group membership changes are rapidly as possible. Alternatively, a Group Membership Service may aggregate membership information at the web server, and present the aggregated results to the Monitor, whenever changes occur in the group membership. Other group membership methods exist and may use the real-time messaging system included in the invention for providing rapid notification of group state or membership changes.

In FIG. 9, User1 (500) may join a group by sending a Join message specifying event identifier “Group23” using a submit-identifier-event message to the web server via interaction 600. It is assumed that the Monitor (500) has already sent a request-for-identified-event message to the web server for event identifier “Group32”. Thus User1's Join message is immediately sent to the Monitor (500) via interactions 602 and 603. An XML representation of the Join message format may be but is not limited to the following:

<message>
<eventIdentifier>Group23</eventIdentifier>
<eventData>

<messageType>Join</messageType>
<userIdentifier>JoePhipps@yahoo.com</userIdentifier>

</eventData>
</message>

The Monitor (500) now knows that User1 is a member of the group identified by the event identifier “Group23”. It is assumed that the Monitor immediately sends a request-for-identified-event message (not shown in FIG. 9) to the web server (504) after receiving any notification messages from the web server. FIG. 9 shows User3 joining the group in interactions 608, 609, 610, and 611. FIG. 9 also shows the Leave process whereby User1 leaves the group identified by event identifier “Group23”. User1 leaves the group by sending a Leave message as shown in interaction 612 to the web server. The Leave message is a submit-identified-event message with the user identifier and message type specified as “Leave” contained in the EventData. An XML representation of the Leave message format may be but is not limited to the following:

<message>
<eventIdentifier>Group23</eventIdentifier>
<eventData>

<messageType>Leave</messageType>
<userIdentifier>JoePhipps@yahoo.com</userIdentifier>

</eventData>
</message>

When a Monitor receives the LeaveNotification message as shown in interaction 615, it now knows that the user is no longer a member of the specified group.

In addition to the Join and Leave messages, FIG. 9 shows the Join Refresh message. FIG. 9 shows that User 1 sends a Join Refresh message in interaction 604 to web server 504 resulting in interactions 605, 606, and the Join Refresh Notification (interaction 607) to the Monitor (500). The Join Refresh message provides an indication to the Monitor that the User is still connected to the service or still has connectivity to the service. The Group Membership application can be designed such that the Monitor expects each member to periodically notify the Monitor via a Join Refresh message. The Monitor can then determine within some reasonable time frame what users are still participating in the group. If one or more users become disconnected from the web server, the Monitor will time-out the users as a member of the group and will thus determine the loss of connectivity of the user to the service and/or Monitor. Detection of group membership during loss of connectivity allows the Monitor to detect users as having become disconnected from the group as a function of the time-out period. However, whenever a user joins or leaves a group, and the connectivity is good, the Monitor would obtain the change in the group membership in real-time. An XML representation of the Join Refresh message format may be but is not limited to the following:

<message>
<eventIdentifier>Group23</eventIdentifier>
<eventData>

<messageType>Join Refresh</messageType>
<userIdentifier>JoePhipps@yahoo.com</userIdentifier>

</eventData>
</message>

In FIG. 9, a Join Refresh message is sent in interaction 604 by User1 to the web server. The Join Refresh message is a submit-identified-event message. The Join Refresh message interacts with the web server, event mediator and then back to the web server in interactions 605, 606. The web server sends to the Monitor the Join Refresh Notification message illustrated in interaction 607.

In an alternate implementation of the application, a Group Membership Service may reside at the web server 504 and aggregate all group state changes, and manage membership time-outs due to loss of connectivity. The aggregated results can be presented by the Group Membership Service to the Monitor in real-time whenever a change in the group membership occurs. This alternate application would require the users to send all Join, Leave and Join Refresh messages to the Group Membership Service using a specified group event identifier. The Group Membership Service may aggregate the results, potentially store them in persistent storage for logging purposes, and provide in real-time to the one or more Monitors whenever any changes in the group membership are detected to the Monitors. The Group Membership Service and the Monitors would communicate using a different event identifier, separate from the one used for the users to provide their membership status to the Group Membership Service.

The group membership capability is important for applications that carryout remote collaboration. For example, in live distance learning applications, it is important that the trainer be provided with real-time feedback concerning what students are connected to the training session. If one or more users becomes disconnected from the training session during the live session, the trainer would be provided an indication of who and how many students where disconnected. The trainer could decide to reschedule the training session, for example, if too many students become disconnected. Furthermore, the training service would know which users where not able to get access to the site, and thus potentially provide compensation for loss of connectivity. In general, the group membership capability provides a quality of service indication that can be used in many ways and in many applications.

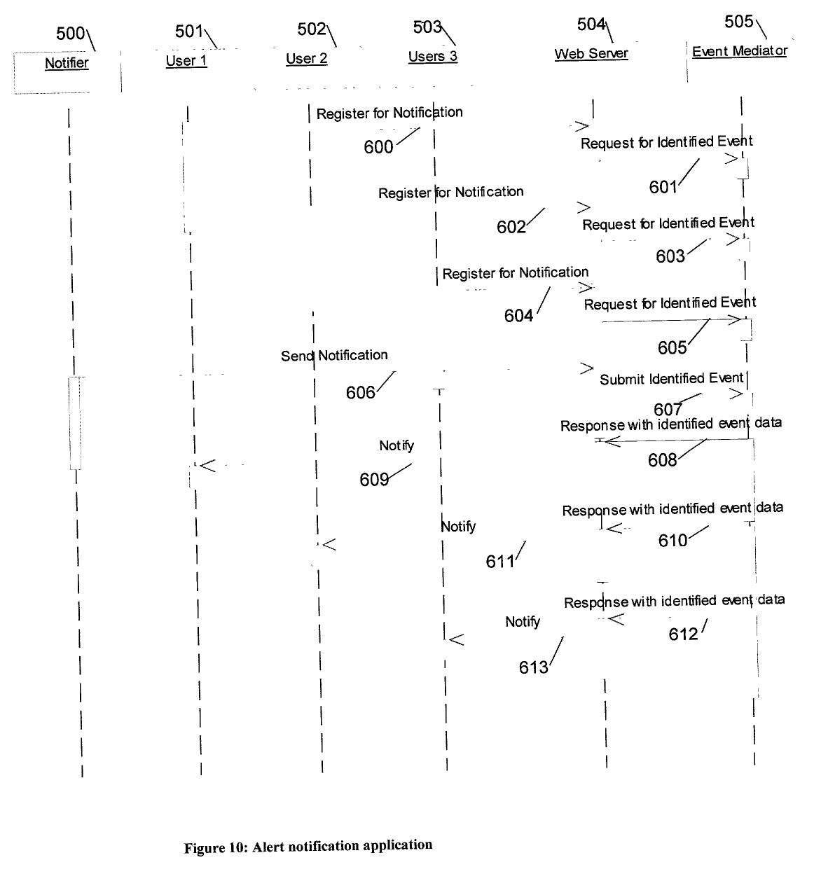

The invention herein includes an application of the real-time messaging system to provide for a real-time alert notification. Users or computers may express interest in an event by sending a request-for-identified-event to the event mediator. Such users or computers are called Alert Monitors. Alert notification messages may be provided by any user or computers, by sending a submit-identified-event message to the event mediator. The event mediator notifies the Alert Monitors of the notification message via a response-for-identified-event message. FIG. 10 shows a system used for alert notification consisting of a Notifier (500), one or more users (501,502, 503), a web server (504), and an instance of the event mediator (505). One or more Notifiers may exist in this application. Users may send a Register for Notification message (600) to the web server (504). The Register for Notification message consists of a request-for-identified-event message. An XML representation of the Register for Notification message format may be but is not limited to the following:

<message>
<eventIdentifier>GossipChannel1</eventIdentifier>
<eventData>

<body>Danny just bought a new house</body>
<priority>Urgent</priority>

</eventData>
</message>

Other users interested in receiving notification concerning the same event identifier also send Register for Notification messages to the web server, which subsequently interacts with the event mediator.

The Notifier (500) may send a Notification message (606) to the web server when a notification is to be sent to the users that have registered interest in the event identifier. The users are subsequently notified via the Notify message (609, 611, 613) in real-time. The users may immediately send a Register for Notification message again to the web server in preparation for the next notification event. This application of the invention can be used to provide real-time updates to users as events happen. This can be used to deliver game scores, stock quotes, network failure events for browser based network management applications, real-time email notification, or any kind of events to one or more users in real-time. This application provides for real-time updates or true “push” of targeted information to user's web browsers, frames within a browser, or computers themselves.

The invention herein includes an application of the real-time messaging system to provide for a real-time annotation system. An annotation system may provide the ability for a sender of a presentation (presenter) to annotate a given web view or slide. The annotation may include but is not limited to highlighting portions of the screen, underlying text, drawing shapes or any object, circling items or any such markup similar to that included in a typical white board application such as Microsoft NetMeeting 3.01. The annotation system may use the real-time messaging system included in this invention to send the annotations between communicating parties, from a sender to receivers, such as from one or more presenters to attendees, or from attendees back to one or more presenters. The annotation actions may be codified prior to being sent. The method by which the annotations are sent is the same as that used by earlier described applications. The sender that is annotating may annotate his local view, and as such, the local annotation application may send the annotation encoding to the other receivers in real-time. The local annotation application at the receivers may receive the annotation encoding message and execute them locally so as to show the annotation as what the sender did, thus causing the same annotation to be viewed at the receivers. Note that the screen size of the local views may be different from the sender's and one or more receivers's. As such, the annotation application at the sender may include but is not limited to the codification of position and screen size information and include it in the message to the receivers so that the position information may be utilized at the receivers local annotation application to more accurately mimic that sender's view. Many additional capabilities may be provided by an annotation application. The invention may be utilized to provide for any kind of annotation between communicating parties, such that the annotations are provided in real-time. Multiple senders or users my annotate one or more views in a many-to-many communication configuration.

The invention herein includes an application of the real-time messaging system to provide for follow-me browsing. The follow-me browsing application may enable a sender (presenter) to bring a group of receivers on a tour of the Internet or other such medium such that the views that are selected by the sender are also shown to the receivers. A sender may be navigating the Internet or any like medium, and as he does so, the navigation, as well as the mouse actions may be shown to the receivers causing the receivers view to be updated just at the senders. The sender may navigate from one web page to another, and as he does so, the receivers will automatically be navigated to those same web pages simultaneously. As the sender moves his mouse, interacts with objects on the web page in his view, such as buttons, hyperlinks and so on, the same actions may be executed at the receiver's view. Follow-me browsing may operate using the invention by having the all or some of the actions carried-out by the senders sent in real-time to the one or more receivers using the real-time messaging invention. The actions, including but not limited to button onclicks, button off clicks, clicks on hyperlinks, mouseover and mouseoff events, the entering of userid and passwords for access to secure sites into textboxes, entering text into textboxes, selecting choices from listboxes, selecting checkboxes or option groups, navigating through record sets, and including all possible browser events for web page objects, for example. These actions, as well as page flip messages may be sent to the receivers in much the same interaction flow as is done in the page flip messaging interactions shown in FIG. 8. Note that multiple senders may be interacting such that either or both or none of the senders may be bringing the receivers through interleaved tours or browsing, thus using many-to-many communications. The annotation, follow-me browsing or any applications may be combined into a single application allowing the senders to lead receivers on a tour of the web, as well as annotate the views shown to receivers.

The invention includes an application of the real-time messaging system to provide a instant messaging system. Features provided by America On Line (AOL) Instant Messaging application or Microsoft's Instant Messaging application are included in the invention. Instant messaging may be implemented using the invention by establishing many one-to-one communication channels between communicating entities where each entity may act as a sender and or a receiver. Furthermore, the application should enable users to be informed if other users are available or on-line at a given time. An instant messaging application of the invention may be implemented by associating a unique event identifier with each individual. The association may be conveniently stored in a directory, or any storage facility. Additionally, when a user is on-line, the directory service may be updated to reflect this condition of the user. If a sender wants to send an instant message to a receiver, the sender may first specify the name or some identifier (e.g., alias name) of the receiver. The event identifier associated with the receiver may be retrieved from the directory service. Furthermore, the directory service may be checked to see if the user is currently on-line. When a user gets on-line, they may issue a request-for-identified-event for their unique event identifier, to be ready to receive instant messages. A sender of an instant message may send the message, via the real-time messaging system, using the event identifier for the receiver user, such that the user may receive the instant message. If the receiver user is not currently on-line, the message may be stored in a queue or other storage facility. When the user does become on-line, the messages accumulated in the queue or storage facility may be delivered to the user. Instant messaging may be implemented for one-to-one communications, one-to-many or many-to-many communications. Also, users are typically senders to other users and receivers of messages sent by other users.

The invention includes an application of the real-time messaging system to provide a chat system. A chat system may be easily implemented by assigning a unique event identifier to the chat group to which all users are senders and receivers for the event identifier. Users send a request-for-identified-event to the web server using the chat group name as the event identifier, for example. Users may send messages to the chat group by sending a submit-identified-event message to the web server were the event identifier is the chat group name. Users may receive chat messages from the chat group whenever a submit-identified-event message is sent to the web server. Features provided by prior art chat applications, such as Microsoft Chat included with Netmeeting 3.01 are included in the invention.

The invention includes an application of the real-time messaging system to provide real-time discussion groups. Typically, discussion group messages are posted to a discussion group (newsgroup), which may take some minutes, hours, days or some significant length of time to make the posting available to discussion group participants. Discussion groups are different than chat groups in that discussion group users can often attach documents to postings, thus making the attachments available to discussion group participants. The real-time messaging invention may be used for discussion groups to enable real-time message posting, including attachments. Thus, discussion group participants may immediately see the postings made by participants. Discussion groups may be implemented using the invention by associating with each discussion group a unique event identifier. Participants that desire to post a message may send the posting message using the event identifier in a submit-identified-event message interaction. Participants that have issued a request-for-identified-event for the given event identifier will receive the postings in real-time. Attachments may be automatically stored at the server, and retrieved by participants on-demand. Alternatively, the attachments may be sent to all participants as part of the real-time message. Attachments may be dealt with in many alternative ways.

The invention includes an application of the real-time messaging system to provide real-time email delivery and or email notification. Browser based email systems are deliver email notification to their users in a non-real-time manner, such that an email message sender may send an email to an email message receiver, but the receiver may not be notified that a new email has arrived until the receiver user refreshes their browser view or the browser polls the server for new email messages. The invention can be used to provide real-time email delivery and or email notification, again with the benefits of not imposing any installation software, plugins or components at the user's browser and with operating through filtering systems. When an email arrives for a user, the user's browser may be automatically refreshes so as to notify the user of the newly arrived email message. Alternatively, the email information may be delivered to the user's browser in real-time such that the full email message is available locally at the user's browser. Alternatively, some subset of the email information may be delivered to the user's browser in real-time, and the user may be required to take some action to retrieve the full email message. In any case, the invention may be utilized to provide for real-time email delivery and or notification by associating with each user a unique event identifier, such as was previously described in the implementation of the instant messaging application. When an email user gets on-line, the user may send a request-for-identified-event to the web server for the user's unique event identifier. When an email arrives at the email server that is serving a given user, the server may first check to see if the user is on-line. In either case whether the user is on-line or not, the server may send a submit-identified-event message containing the entire email message, or some portion of the email message, using the user's unique event identifier, such that the user receives the email message, part of the email message, or updates their browser view to show the arrival of the email message. There are many alternative ways of providing real-time email and or email notification using aspects of the invention.

The invention includes an application of the real-time messaging system to provide for text based speech. In this application of the invention, text may be sent from one or more senders to one or more receivers using the messaging invention. The receiver may provide the text to a speech processing engine that may convert the text to audible speech corresponding to the text of the speech. Such technology is emerging and will be provided natively in the Microsoft Windows 2000 operating system whereby text may be converted to audio and played to the end user. The text based speech processor may be used in conjunction with the messaging system such that the text may be carried from sender to receiver using the real-time messaging technology. Once the text is received, it may be provided to the speech engine for audio playback to the receiving user. Senders may additionally use the speech engine to convert their spoken word to text, at which point the text may be sent over a communication system to receivers using the real-time messaging system. Note that the playback may be provided in different dialects, accents, or voices, e.g. male, female. That is, the application may include the ability to send text to multiple recipients, each of which listens to the text in a different dialect, language or accent. Also, multiple languages may be supported.

Multiple event mediators may be arranged in a hierarchical tree or graph, or in any arrangement and thus be organized as a system of event mediators. In this configuration, event identifiers need to be unique across all event mediators that participate within a system of multiple event mediators. Such a system may provide large scale real-time messaging capabilities for handling millions of events per day.

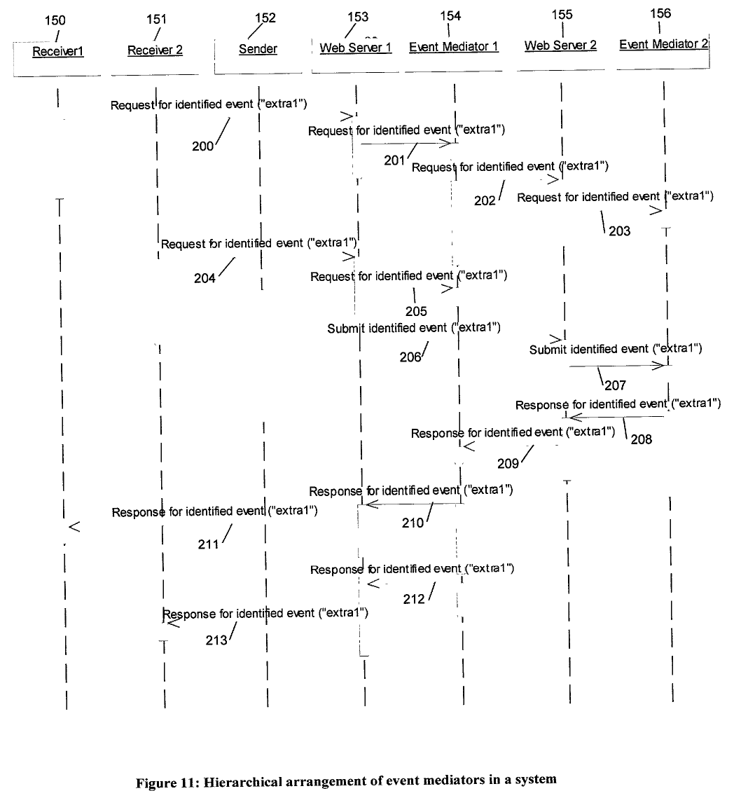

If such a configuration is used, all of the applications of the preferred embodiment (real-time messaging system) may be extended to use multiple event mediators participating in a system in any configuration. For example, FIG. 11 shows a hierarchical arrangement of event mediators and web servers such that when a sender sends a submit-identified-event message to the “top” level web server, the event response message is delivered with a high degree of fan-out such that all receivers and children event mediators and web servers may rapidly receive the message. This type of configuration is useful for providing large scale real-time messaging. FIG. 11 shows two receivers (150,151), a single sender (152), and two web servers and their corresponding event mediators. Web server 1 (153) uses event mediator 1 (154), and web server 2 (155) uses event mediator 2(156). In this example, event mediator 2 (156) is the “top” level event mediator in the hierarchy. Receiver 1 (150) sends a request-for-identified-event message to Web Server 1 (153) via interaction 200, which subsequently interacts with event mediator 1 (interaction 201) for the event identifier “extra1”. Event mediator 1 (154) is arranged in a hierarchy and as such forwards the request to its parent web server via interaction 202. Web Server 2 (155) provides the request to event mediator 2 (156) via interaction 203.

Receiver 2 (151) sends a request-for-identified-event message to Web Server 1 via interaction 204, which forwards it to the event mediator 1 (154) via interaction 205. Since the event mediator 1 has already forwarded a request-for-identified-event message for the event identifier “extra1” to Web Server 2 and still has it outstanding, message, it does not necessarily need to forward the request to its parent web server, Web Server 2 (155).

If a sender sends a submit-identified-event message to Web Server 2 (via interaction 206) and subsequently to the parent event mediator 2 (156), the response for identified event interaction is initiated by the event mediator 2 via interaction 208, and 209. The event mediator 1 is responded to via interaction 209. Event mediator 1 subsequently issues a response for identified event for all outstanding requests that it is managing for the event identifier “extra1”. Thus, event mediator 1 responds to outstanding requests via interactions 210 and 212, which subsequently cause Web Server 1 to deliver the real-time message to Receiver 1 and Receiver 2 respectively for the identified event “extra1”. Thus, it is described how web servers and event mediators may be combined in a hierarchy to support large scale real-time messaging.

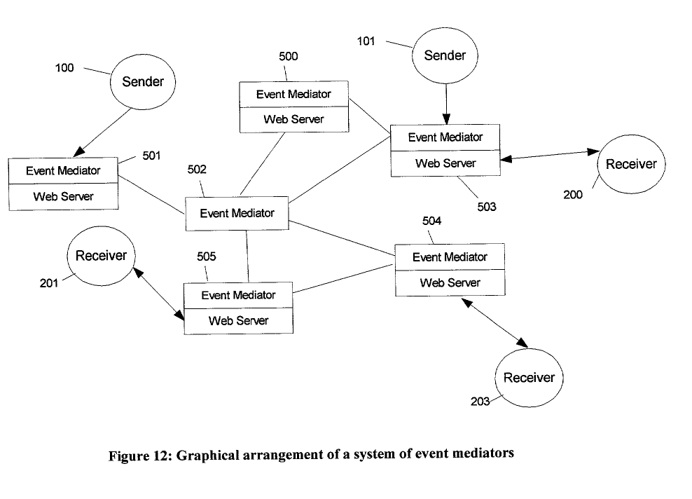

Event mediators and web servers may be combined in any kind of configuration, as abstract as a graph. For example, FIG. 12 shows web servers and event mediators arranged in a graph. In this example, event mediator (502) need not require a web server for communications. For example, event mediators may interact with each other using any communication method, such as TCP, UDP, DCOM, CORBA, and RPC for example. Thus, the web server may be optional for inter-event mediator communications. However, the invention still may use a web server for interacting with the senders and receivers over the HTTP protocol or variants of the protocol. FIG. 12 illustrates the flexibility in configuring web servers and event mediators to provide extremely flexible, highly scalable real-time messaging systems. The system may operate as follows. When a receiver sends a request-for-identified-event message to its local web server or event mediator component, the component may send a request-for-identified-event message to all other web servers or event mediator components for the identified event. A local receiver or send is one that communicates directly with the web server or event mediator component for receiving and sending messages, respectively. When a sender sends a submit-identified-event to its local web server or event mediator component, the component sends one or more response messages directly to any or the component's local receivers and to other web server or event mediator components that had previously issued to the local web server or event mediator component a request-for-identified-event messages for the same event identifier. Subsequent web server or event mediator components may respond to their local receivers and to other web server or event mediator components that had previously sent the local component a request-for-identified-event messages for the same event identifier. In this manner, all senders and receivers are able to send and receive the message in real-time from their local web server or event mediator component, and the message is able to propogate through the system from web server or event mediator component to component, in support of a large scale messaging system able to serve many users and messages per second.

It has been stated that the invention may operate using the HTTP protocol and its variants. A specific protocol variant that is of great importance is the HTTPS, or secure HTTP protocol. Additionally, there is the Transport Layer Security (TLS) and SSL (Secure Sockets Layer) that provides secure communications over HTTP or other protocols. The invention may operate using any of these protocols thus providing for a highly secure real-time messaging system The applications specified in the invention as well as any application that may take advantage of the real-time messaging system included in this invention may also operate using these secure protocols. Thus, the applications may be provided over such secure communication channels and provide for real-time message. More specifically, the real-time polling, page flip, group membership, altert notification, annotation system, follow-me browsing, chat, discussion groups, and email may all operate in real-time using these secure communication protocols. Any application that may be written using the included real-time messaging system may also operate in a secure manner using any secure underlying protocol.

The real-time messaging system may be interacted with using the Java Messaging System (JMS) Application Programming Interface (API), specified by Sun Microsystems. JMS provides includes a publish and subscribe interface. The JMS API may be used as an alternative API to interact with the real-time messaging system. The JMS API provided by the real-time messaging system may be implemented in Javascript, Visual Basic Script (VBScript) or any language.

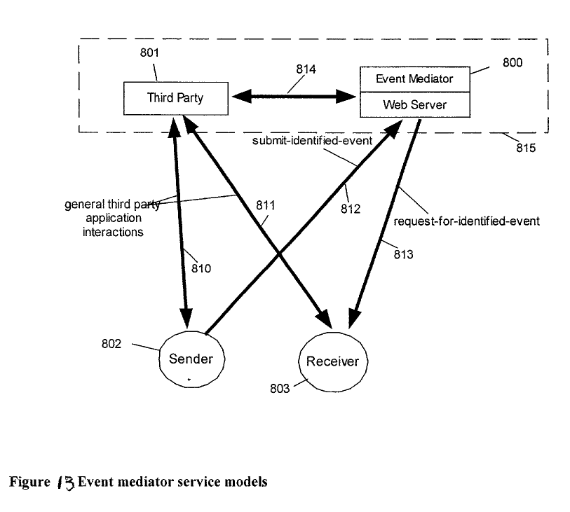

The invention includes an application of the real-time messaging system to make available the messaging system and one or more of its applications as a service. In this application of the invention, the messaging system may be provided to third party entities (e.g. web service providers), as a real-time messaging service. This would provide to the third party entities the ability to deliver real-time messaging, and the applications that benefit from such messaging, over the Internet or similar medium such that the users are not required to download any installation programs, plug-ins, or use any components such as Java, ActiveX, and the messaging system and corresponding applications will operate through filtering devices. The service model can provide all of the benefits of using the messaging technology to third party entities, without requiring that the third party entity to run an infrastructure that provides for such real-time messaging. The invention includes, but is not limited the system in which the real-time messaging system may be provided to third party entities as a service. FIG. 13 shows an example of a service model for the real-time messaging system comprising of one or more third party entities 801, examples of which may any be web service sites, one or more real-time messaging systems (800), and users 802 and 803, where one or more users may be senders, receivers and or both senders and receivers. Users normally interact with the third party entity for access to the third party offered services. The third party entity may provide to its users one or more real-time messaging applications. When a third party user commences use of a real-time messaging application, the real-time messaging or the real-time application, may be provided by the real-time messaging system (800) which may or may not be co-located with the third party entity's operations facility. For example, if a third party entity offers a chat application as part of its service offering to its customers (802,803), the chat application messaging may be provided by the real-time messaging system (800) rather than the third party (801) itself. Again, the third party may host in its data centers only 801 or both 800 and the real-time messaging system (801), all contained in 815. To continue the example, the chat application may be serviced out of the third party facility (801), but when messaging between senders and receivers is required, the application may interact with the real-time messaging system (800) shown in flows 813 and 812. A user of the chat application that may receive messages may send a request-for-identified-event (813) to the real-time messaging system (800) when starting the chat application. A user that wants to send a chat message (802) may submit a submit-identified-event (812) to the real-time messaging system, which may subsequently deliver the chat message to the receiver (803). The event identifiers used for the real-time messaging interactions may be coordinated by interaction 814. Furthermore, interactions 814 may be used to authenticate and authorize users to the real-time messaging system, such that they users are privileged to use the real-time messaging system (800). In this application of the invention, message delivery from senders to receivers interacts with the real-time messaging system (800), the real-time messaging system (800) may include but not be limited to tracking of the number of messages, number of bytes used by receivers, senders or third party entities, and other statistics that may be useful in billing third party, and or users for use of the real-time messaging system services.

To summarize, the invention may be used but is not limited to the use of the http protocol or any of its variants. The applications specified in the invention may use the real-time messaging system over http or its protocol variants without requiring that the users to install additional software beyond a browser, and may operate seamlessly through security filtering devices providing real-time communications. The capability of providing real-time messaging without inconveniencing the users with software installations or the use of specialized component controls, in combination with seamless real-time messaging operation through filtering devices over http, https, for example, provides an important differentiator and argument for using the invention in many applications on the Internet.

The system described above includes a variety of embodiments. Other embodiments are considered within the scope of the invention. The invention is known through the following claims.

1. A system for obtaining information comprising a server, a sender and a receiver and a communication means for said server to communicate with said sender and receiver and wherein said receiver initiates a request message which is transmitted to said server, wherein in the event said server is unable to immediately reply to said request with information for said receiver, said server retains said request in a pending state until a time when said server is able to respond to said request with information for said receiver and wherein at such time, said server allows for the completion of said receiver request with said information,

2. The system according to claim 1 wherein the protocol used for said receiver and said server communications consists essentially of http, https, httpdav or any other variant of the http protocol.

3. The system according 2 wherein said receiver includes a browser.

4. The system according to claim 3 wherein said receiver is a computer and the computer, where said browser is executing, does not require the installation of additional software to receive a response from said server.

5. The system according to claim 4 wherein said receiver does not require the use of Java Applets, ActiveX controls or any other automatically downloaded control component to receive response from said server.

6. The system according to claim 4 wherein said computer requires the use of Javascript.

7. The system in claim 2 wherein said receiver includes a web browser and said server includes a web server.

8. The system according to claim 2 wherein said server includes a web application server.

9. The system according to claim 2 wherein the server provides durability.

10. The system according to claim 2 wherein, in the event said server has multiple information items available for delivery to said receiver, the said server may combine said multiple information items in a single response to said receiver.

11. The system according to claim 2 wherein in the event said sender has multiple information items available to send, said sender may combine multiple information items in a single interaction with said server.

12. The system according to claim 2 further comprising, an event notification system to provide one-to-one, one-to-many and many-to-many communications wherein each communication channel is uniquely identified by a unique identifier.

13. The system according to claim 12 wherein said unique identifier is a string or number.

14. The system in claim 13 wherein the event mediator has an application programming interface.

15. The system according to claim 14 wherein the application program interface is a Java Messaging Service Interface or a subset thereof.

16. The system according to claim 2 used for a question and answer.

17. The system according to claim 2 used for real-time polling.

18. The system according to claim 2 used for page flipping.

19. The system according to claim 2 used for group membership.

20. The system according to claim 2 used for alert notification.

21. The system according to claim 2 used for follow-me browsing.

22. The system according to claim 2 used for instant messaging.

23. The system according to claim 2 used for chat.

24. The system according to claim 2 used for discussion groups.

25. The system according to claim 2 used for real-time email delivery and notification.

26. The system according to claim 2 used for text based speech.

27. A system by which communicating entities using a communication protocol may send and receive messages in real-time, said system comprising a http, https, httpdav or any variant of the http communication protocol stack executing on a web server, an event mediator, and one or more communicating entities wherein said event mediator coordinates a receiver request and a response message and wherein any entity that desires to receive real-time messages is associated with an event identifier managed by said event mediator such that an entity submitting a submit-identified-event message to said web server has its request forwarded to said event mediator, said event mediator receiving said message from the web server and matching it with one or more receiver outstanding requests for the same identified event, said event mediator generating a response to said request and sending said response back to said receiver for responding to previously submitted request-for-identified-event messages sent to said web server that had said request forwarded to said event mediator.

28. A method of sending and receiving messages in real time comprising
a) a receiver submitting a request-for-identified-event message to a server;
b) said server forwarding said request-for-identified-event message to an event mediator;
c) a sender submitting a submit-identified-event message to said server;
d) said event mediator receiving said submit-identified-event message from said server and matching it with one or more receiver outstanding requests for said same identified event;
e) said event mediator sending a response back to said server for one or more previously submitted request-for-identified-event request, said server sending the corresponding response to said receiver.

29. The method according to claim 28 wherein said sender submits said submit-identified-event message to said server and said receiver submits a request-for-identified-event message to said server at any time with respect to each other.

30. The method according to claim 28 wherein said receiver may send a request-for-identified-event message to said server immediately after receiving said response to a previously submitted request-for-identified-event message.

31. The system in claim 27 wherein said system is used as a messaging service to a third party service provider, wherein said system is provided by a messaging service provider, where one or more third party service provider users may utilize said system provided by said messaging service provider for providing to said users real-time messaging applications, wherein said third party service provider provides consideration to said messaging service provider for said users use of said messaging service.

32. The system according to claim 2 wherein all or part of any communication is encrypted.

33. The system according to claim 2 wherein all or part of any communication is server side authenticated.

34. The system according to claim 32 wherein SSL is used as said underlying communication protocol.

35. The system according to claim 33 wherein SSL is used as said underlying communication protocol.

36. The system according to claim 32 wherein TLS is used as said underlying communication protocol.

37. The system according to claim 33 wherein TLS is used as said underlying communication protocol.

38. The system according to claim 1 wherein all or part of any communications may be secured via a Virtual Private Network.
